(19) United States
(12) Patent Application Publication
(10) Pub. No.: US 2014/0119627 A1
(43) Pub. Date: May 1, 2014

(54) Method for improved estimation of tracer uptake in physiological image volumes

(71) Applicant: Universitetet i Oslo, Oslo (NO)

(72) Inventors: Arne Skretting, Billingstad (NO); Christopher Coello, London (GB)

(73) Assignee: Universitetet i Oslo, Oslo (NO)

(21) Appl. No.: 13/998,390

(22) Filed: Oct. 29, 2013

(30) Foreign Application Priority Data
Oct. 29, 2012 (GB) 1219403.1

(51) Int. Cl. G06T 7/00

(52) U.S. Cl. CPC G06T 7/0012
USPC 382/131

(57) ABSTRACT

A method of estimating the true uptake of a tracer in a physiological image acquired with a physiological image modality that has limited spatial resolution comprises: co-registering an anatomical image volume and the physiological image volume such that both image volumes have corresponding voxels; segmenting the anatomical image volume into a number of non-overlapping anatomical regions; combining each of the segmented anatomical regions with a function representative of the limited spatial resolution of the physiological image modality to generate a blurred anatomical region volume for each of the segmented regions; assuming the physiological image in each voxel to be a linear sum of the image intensities of the corresponding voxels in the blurred region volumes in that voxel; estimating, for each voxel, a value representative of the contribution to that voxel from each blurred region volume based on the uptake measured by the physiological image for that voxel and for nearby voxels; and using the estimated values for the voxels to estimate a true uptake of the tracer in each voxel and to thereby establish a corrected physiological image volume.

### COLOR DRAWING STATEMENT

The patent or application file contains at least one drawing executed in color. Copies of this patent or patent application publication with color drawing(s) will be provided by the Office upon request and payment of the necessary fee.

### CROSS REFERENCE TO RELATED APPLICATION

This application is related to and claims the benefit of British Patent Application Number 1219403.1 filed on 29 Oct. 2012, the contents of which are herein incorporated by reference in their entirety.

### TECHNICAL FIELD

The present invention relates to a method of estimating the true uptake of a physiological tracer in a physiological image acquired with a physiological image modality that has limited spatial resolution.

### BACKGROUND

Physiological imaging techniques such as emission tomography, including single photon emission computed tomography (SPECT) and positron emission tomography (PET), make it possible to estimate parameters characterizing physiological and molecular processes, such as ejection fraction for characterizing the cardiac function, glucose metabolic rate (GMR) for assessing myocardial viability or staging tumours, or dopaminergic transporter density for brain disease diagnosis. This estimation of parameters is extremely appealing for many applications, as it results in much richer information than the only visual interpretation of images. This is especially true for differential diagnosis, when comparing a parameter value with a certain threshold can help determine the proper diagnosis, for prognosis, as the value of a physiological parameter can help stage the patient, for therapeutic management, and probably even more important, for therapeutic follow-up and radiotherapy. It is known that physiological functions of anatomical structures can be studied by imaging the uptake of certain tracers using physiological imaging modalities. The regional patterns of the tracer uptake may in certain circumstances allow the identification or diagnosis of a pathological condition within the imaged anatomical structure.

To derive physiological parameters from physiological images such as SPECT or PET images, a required step is to determine the relationship between the pixel values and the radiotracer concentrations. A number of phenomena introduced by the imaging process make this relationship highly nonlinear. However, the physics of emission tomography being well understood, these phenomena are now identified. The most important to be aware of are patient or organ motion, photon attenuation and scatter, limited spatial resolution of the tomograph, sampling, tomographic reconstruction, and measurement procedure.

This disclosure is particularly concerned with effects arising from the limited spatial resolution of physiological imaging techniques. Due to the limited spatial resolution of the imaging modality, a point source of a tracer will appear in the image as a 3D distribution of activity. If the actual tracer distribution is considered as consisting of a fine regular network of sub-pixel sized point sources of different strengths, the effect of image formation is that the intensity of each of the point sources undergoes a diffusion process in space.

In an image volume considered to be made up of a plurality of voxels (3D pixels), each voxel reflects the sum of contributions from point sources in the actual voxel and in the neighbourhood of that voxel. Mathematically, this effect can be described as a convolution between the true (or actual) tracer distribution (the activity distribution) and the 3D point spread function (PSF) of the image formation process. The term intensity diffusion may be used interchangeably with the term ‘partial volume effect (PVE)’ (although intensity diffusion can be seen as a more precise description of the effect).

The diffusion effect can bias measurements of the amount of tracer activity (tracer uptake). For example the tracer uptake may appear reduced in high-uptake regions and may appear increased in a low-uptake region adjacent to it. It is therefore essential in the field of physiological imaging to be able to distinguish the changes of tracer uptake that appear in the image due to intensity diffusion from those due to the true changes of tissue function. This may be achieved by correcting the image to account for the intensity diffusion effect.

A number of correction methods for intensity diffusion in physiological imaging (such as PET imaging) are known.

The process of intensity diffusion (ID) can be modelled as a linear system. For a spatially invariant point-spread function psf(r), the measured image g(r) of a distribution of activity f(r) can be expressed as:

g(r)−psf(r) [symbol] f(r)+η(r) (1)

where η(r) is the contribution of an additive noise, [symbol] is the convolution operator and r is the position in the image space. Intensity diffusion correction consists in finding the best solution \hat{f}(r) of equation (1) while limiting the noise amplification due to the correlation process. Considering a distribution of activity described by n voxels, equation 1 can be written in the matrix domain:

g=Pf+η (2)

where P is a n×n matrix containing the information about the diffusion process, f is a n×1 vector of the true distribution of activity, η is a n×1 vector of the uncorrelated noise, g is a n×1 vector of the measured distribution of activity. Different approaches can be used to calculate the best estimate \hat{f} of vector f.

A known approach for calculating the best estimate \hat{f} of vector f is the Geometric Transfer Matrix (GTM) method. This is a region-based method, in which the output of the algorithm, \hat{f}_{GTM} is an estimation of the mean activity in a limited number of regions. Considering that the delineation of s regions of assumed uniform uptake can be achieved on the physiological image (using a co-registered anatomical image for example) and that the noise is considered uncorrelated, equation (2) can be rewritten after some manipulation:

\hat{f}_{GTM}=GTM⁻¹gₛ (3)

where GTM is the s×n geometric transfer matrix, gₛ is a s×1 vector of the mean measured activity in the s regions and \hat{f}_{GTM} is a s×1 vector of the estimated mean activity in the s regions.

The GTM algorithm recovers the activity in all regions, but only provides estimates of the mean activity within each of the delineated regions.

### BRIEF SUMMARY

In a first aspect, the present invention provides a method of estimating the true uptake of a tracer in a physiological image acquired with a physiological image modality that has limited spatial resolution, the method comprising: acquiring a physiological image volume; acquiring an anatomical image volume with an anatomical image modality of higher spatial resolution than the physiological image modality; co-registering the anatomical image volume and the physiological image volume such that both image volumes have corresponding voxels; segmenting the anatomical image volume into a number of non-overlapping anatomical regions; combining each of the segmented anatomical regions with a function representative of the limited spatial resolution of the physiological image modality to generate blurred anatomical region volumes for each of the segmented regions; assuming the physiological image in each voxel to be a linear sum of the image intensities of the corresponding voxels in the blurred region volumes; estimating, for each voxel, a value representative of the contribution to that voxel from each blurred region volume based on the uptake measured by the physiological image for that voxel and for nearby voxels; and using the estimated values for the voxels to estimate a true uptake of the tracer in each voxel and to thereby establish a corrected physiological image volume.

This method corrects for the limited spatial resolution encountered in different sorts of physiological imaging devices (such as PET, SPECT etc). For example, the wide point spread functions of such imaging devices causes an apparent diffusion of the tracer (intensity diffusion) in the image. This can also be described as a blurring of the physiological image volume. As described above, this means that a small region inside the object that contains a high concentration of tracer will appear in the image as if the tracer has undergone a physical diffusion that lowers its concentration and increases it in adjacent neighbour regions. With a spatially complex distribution of tracer, such apparent diffusion effects lead to wrong tracer uptake being reported for distinct anatomical regions. Specifically the method allows the separation of contributions from tracer uptake in different anatomical regions of a physiological image. The result is an estimate of the true tracer uptake in each voxel of each specified anatomical region of the image volume.

The intended effect of the method is to provide better estimates for the tracer uptake in each voxel and thus enable more precise diagnosis.

An anatomical image volume is an image volume that shows detailed anatomical structures of the actual body part from which anatomical regions may be extracted (segmented) by manual or automatic delineation. For the above method it is possible that the anatomical image volume may be based on previously obtained anatomical image data, for example using so called anatomical atlases based on histological sections. This can allow for co-registration of a physiological image and segmentation into overlapping anatomical regions without the need for new anatomical image data to be obtained. However, it is preferred for the anatomical image volume to be acquired from the patient, for example via an anatomical imaging system such as MRI or CT imaging.

A physiological image volume is an image volume obtained after administration of a tracer that is accumulated in different concentrations in different regions of the actual body part and reflects some physiological function (for example, glucose metabolism).

A tracer is a biomolecule injected in low chemical quantities and labelled so that it can be detected by an external device (by a physiological image modality such as a PET-scanner or a SPECT-scanner). The label is often a radionuclide.

The method of the first aspect utilises the availability of high resolution anatomical images obtained by means of other medical imaging modalities such as magnetic resonance imaging (MRI) or computer tomography (CT). A necessary prerequisite for the use of the method is that the images provided by these modalities can be reliably segmented into the regions of interest, such as class of tissue, for physiological quantification, for example via PET. The segmentation of the anatomical image may comprise generating anatomical image region volumes representing the different anatomical image and assigning voxels within a region a value equal to 1, with the remaining voxels having a value of 0.

The nearby voxels which are used to estimate the value representative of the true uptake are preferably neighbouring voxels to the central voxel and in a preferred embodiment are a set of adjacent voxels. For example, the nearby voxels may be a cube of voxels surrounding the voxel for which the values are being determined (the voxel of interest). Alternatively the nearby voxels may be a set of voxels approximating a sphere surrounding the voxel of interest.

In some preferred embodiments the function representative of the limited spatial resolution of the physiological image is a point spread function of the physiological imaging modality. The step of combining each of the regions with a function representative of the limited spatial resolution may involve convolving each of the segmented anatomical region volume with the point spread function (psf(r)). Any suitable method of convolution may be used. This generates a blurred region volume which is an estimate of the effect that the physiological imaging modality would have on the image, i.e. it is trying to adjust the image taken with the higher resolution imaging modality to simulate what the image would look like if it had been taken with the lower resolution imaging modality.

Precise geometrical co-registration (within the same frame of reference) between the physiological image volume and the anatomical (e.g. MRI/CT) image volumes is required. Co-registering of the anatomical image volume and the physiological image volume may be carried out by any suitable technique. For example the step of co-registering may comprise ‘re-slicing’ of the original voxels of the physiological image volume to produce a new voxel set corresponding to the voxels of the anatomical image. It is preferred to increase the number of voxels in the physiological image to co-register the images since with this technique no information is lost. Alternatively an algorithm may be used to combine voxels within a higher resolution anatomical image to produce voxels corresponding to and co-registered with the voxels of the lower resolution physiological image.

An estimate of a value representative of the true uptake in each region i.e. the actual distribution activity for each region, is calculated for use in correcting the image. It is assumed that the value representative of the true uptake in each region is slowly varying. This assumption means that the values need to be calculated for each voxel (in each anatomical region) individually but the fact that it is slowly varying means that the uptake indicated by the physiological image data for nearby voxels can be used in calculations to determine the value.

In a preferred embodiment a regression analysis is used to determine the estimated values, these values hence taking the form of linear coefficients determined by the regression analysis. For each voxel, a regression analysis may be performed based on the imaged uptake in the analysed voxel and its nearby voxels, such as a surrounding cube of voxels, to estimate the actual distribution of activity for each region in each voxel. This is repeated for each voxel and one regression is achieved per voxel.

This preferred method combines the assumption of linear combination of blurred (ideal) volumes and uses a local approach to provide an estimation of the linear coefficients by regularised regression analysis.

The step of estimating the true uptake of the tracer in each voxel based on the estimated values preferably comprises selecting one of the estimated values to use as the basis for the correction to the measured uptake, the selected estimated value being that associated with the anatomical region identified with the voxel concerned. Preferably, the anatomical region identified with the voxel concerned is determined by reference to the original anatomical image volume (i.e. the volume prior to blurring). For example, where the co-registration step involves the preferred method of generating increased voxels for the physiological image volume then the anatomical region identified with the voxel concerned can be easily determined by reference to the corresponding voxel of the original anatomical image. The original unblurred anatomical image will of course indicate a single anatomical region (for example tissue type) for each voxel of the anatomical image.

A method according to at least a preferred embodiment comprises the following steps: A high resolution anatomical image set is obtained for a body part and segmented into the required regions which are preferably non-overlapping and usually based on tissue classes. A physiological image set is obtained after injection of the tracer. The two image sets are co-registered. Finally, an algorithm is used to estimate as many sets of image volumes of the distribution of tracer uptake as there are segmented regions.

A simple explanation of an algorithm utilised in preferred embodiments is as follows, using PET imaging by way of example:

Assume that a 3D region ‘i’ (which does not need to be contiguous) has a uniform distribution of tracer uptake aᵢ(x,y,z) of uptake level fᵢ. The PET image of that only region i would be:

gᵢ(r)=psfᵢ(r) [symbol] (fi·ai(r))=fᵢ·psfᵢ(r) [symbol] aᵢ(r) (4)

where [symbol] stands for 3D convolution and psf(r) is the effective point spread function of the PET image volume. The parameter fᵢ is a constant value within the region i, ai(r), which is preferably set to 1 inside the region i and zero outside.

The values fᵢ for several regions could be estimated by minimizing the difference between the noisy observed physiological (PET(r)) image and the modelled contribution of each region (eq.4):

\hat{f}=min_{f}_{ᵢ}((PET(r)−Σᵢgᵢ(r))²)=min_{f}_{ᵢ}((PET(r)−Σᵢ(fᵢ·psfᵢ(r) [symbol] aᵢ(r)))²) (5)

This equation represents a regression analysis that would estimate the global (i.e. the whole image set) quantities \hat{f}ᵢ for each region.

The algorithm may assume that the tracer uptake within each region varies slowly from one voxel to the next. This means that the fᵢ of equation above is a parameter that can be calculated for a volume, such as a cube or a sphere of voxels, where the actual voxel r for which the values of fᵢ (one for each region) are to be estimated sits in its centre.

In preferred embodiments, this volume is slid across the entire image volume, calculating for each position an estimate for the fᵢ of the centre voxel based on the uptake indicated by the physiological image (e.g. PET) for nearby voxels.

This regression analysis results in an estimated distribution of the physiological parameter fᵢ for each region i. Since a unit uptake was assumed above, fᵢ(r) is an estimate of the uptake of tracer at voxel r in region i. The processing method may hence be termed local regression analysis (LoReAn).

The function representative of the limited spatial resolution of the physiological image modality may be the point spread function. This is a (2 or) 3D function that defines how a point source of the tracer is captured by the imaging process. The point spread function is characterized by its full-width at half-maximum (FWHM), this parameter is of the order of 6 and 12 mm for PET and SPECT imaging modalities, respectively.

The point spread function may be determined by a) acquiring the line spread functions in three directions using a thin tube filled with ¹⁸F, b) normalizing the results to form integrals=1.0, c) building spatial cumulative functions at each pixel border and c) fitting the Gaussian cut-off values obtained for each of the cumulative values to the corresponding left pixel border coordinates by regression analysis.

The Gaussian cut-off value x is given in terms of the number of standard deviations up to the point where the probability of finding a free variable above x is equal to the actual cumulative function. The angular coefficient of the regression line is the inverse of the spatial standard deviation of the underlying Gaussian distribution.

A preferred embodiment provides a method of compensating at a voxel level for the intensity diffusion (or PVE) that occurs in a positron emission tomography (PET) image of the uptake of a tracer in an anatomical region structure such as a brain.

The method may hence be used to correct errors in the PET signal (PET image) arising from the limited spatial resolution of the PET scanner which means that the true and/or improved physiological tracer uptake can be estimated at the voxel level. The method of a preferred embodiment takes the original PET image (PET volume) together with anatomical structures segmented from e.g. MR-images as input, and provides as an output an estimate of the true physiological tracer uptake in each voxel of the image volume. The partial volume effect problem in positron emission tomography (PET) imaging can thus be solved at a voxel level and this is achieved by using regional information from co-registered magnetic resonance images (MRI). The distribution of the tracer in the corrected physiological image volume is an estimated quantity which takes into account the diffusion effect that would occur in respect of each class of tissue in each voxel.

The anatomical and physiological images may be taken by different machines and these machines may be in different locations. However, in a preferred embodiment the anatomical and physiological images are taken by a simultaneous anatomical/physiological scanner, for example a combined MRI/PET imaging machine. The images may be taken simultaneously. This provides the advantage that the two images will be co-registered by the machine such that there is no misregistration between the anatomical and physiological image volumes when they are combined. If the two images are not imaged by the same machine there may be some misregistration between the two images, which needs to be addressed by some suitable co-registration algorithm. Current methods for automatic coregistration have been shown to perform very well. Misregistration can reduce the effectiveness of the correction algorithm and thus taking the images together can avoid this problem altogether.

As an example of an embodiment of the invention, the uptake of ¹⁸F-FDG in white and grey matter of the human brain has been studied. In this case one is able to segment a MRI volume reliably into non-overlapping regions based on the tissue types, e.g. grey matter (gm(r)) and white matter (wm(r)) regions. Assuming uniform uptake throughout the grey and white matter regions, respectively, one may form a h_{GM}(r) and a h_{WM}(r) volume by the operations:

h_{GM}(r)=gm(r) [symbol] psf(r) (6)

h_{WM}(r)=wm(r) [symbol] psf(r) (7)

where psf(r) is the effective point spread function (usually a. Gaussian kernel). Under this hypothesis, any voxel of the measured distribution of activity (the FDG-PET volume) can be described as the weighted sum of the contribution of the two regions of uniform uptake:

g(r)=h_{GM}(r)·f_{GM}(r)+h_{WM}(r)·f_{WM}(r)+η(r) (8)

In a generalised form, the image volume g(r) of a voxel r is represented by the following equation:

$$g ( r ) = ( {\sum }_{nreg} {h}_{i} ( r ) \cdot {f}_{i} ( r ) ) + η ( r ) \qquad ( 9 )$$

wherein hᵢ(r) is the factor representative of the limited spatial resolution, fᵢ(r) is the coefficient representative of uptake for each region i at voxel r, η(r) is the contribution of additive noise and nreg is the number of regions

If the uptake in the two tissue regions were uniform throughout the entire anatomical structure, the two parameters f_{GM}(r) and f_{wm}(r) would also be uniform throughout the brain, and represent a global ratio between the uptake in the two classes of tissue. However, the preferred algorithm assumes that the two parameters vary according to the local function of the tissues, and therefore f_{GM}(r) and f_{WM}(r) needs to be estimated for each voxel r of the volume. This estimation is performed by sliding a fixed cubic region over the volume and computing f_{GM}(r) and f_{wm}(r) for the central voxel by regression analysis using voxels in the neighbourhood of r:

$$\hat{f} ( r ) = {min}_{f ( r )} \{ {‖ h ( r ) f ( r ) - g ( r ) ‖}^{2} \} \qquad ( 10 )$$

∥•∥ being the 2-norm of the vector. The underlying assumption is that f_{GM}(r) and f_{WM}(r) are slowly varying within the image volume.

The above equations and discussion apply irrespective of the imaging modalities, the particular tracer used and the structure being imaged, i.e. they do not only apply to images obtained by PET and MRI with 18F-FDG of the brain.

By using a regularisation algorithm it is possible to limit the increase of variability in the solution. It should be noted that since the anatomical regions are non-overlapping, only one of the regression parameters (f) is taken as an estimate and stored into the actual voxel.

In the preferred embodiment the regularised regression analysis is Tikhonov regularization. This modifies the minimisation problem of Equation (10) by the introduction of a second term:

$${min}_{f ( r )} \{ {‖ h ( r ) f ( r ) - g ( r ) ‖}^{2} + λ {‖ f ( r ) ‖}^{2} \} \qquad ( 11 )$$

The parameter λ controls how much weight is given to minimisation of ∥f(r)∥ relative to minimisation of the residual norm.

The Tikhonov parameter may be determined visually by testing different values and plotting an “L-curve” representing the noise versus the bias for a series of measurements. The optimal value for the parameter is dependant on the quantity of noise in the volume but is independent of the anatomical structure and class of tissue. This means that the parameter could be calibrated once with a phantom study and would not need any further tuning each time it is used.

The nearby voxels upon which the estimation of the tracer uptake is based may be a small cube surrounding and including the actual volume element (voxel) that is the subject of the estimation. It may be any volume but is preferably a volume of 3×3×3 voxels, 5×5×5 voxels or 7×7×7 voxels. As noted above a sphere of voxels may alternatively be used. The size of the domain is preferably chosen in relation to the full width half maximum (FWHM) of the effective Gaussian point spread function (PSF_{eff}) of the scanner, including post-reconstruction filtering.

A larger local domain will be less prone to instability due to noisy data, but on the other hand, details of the size of the domain or smaller will be smoothed, risking the loss of some information. In the preferred embodiment the domain is 5×5×5 mm³ (Ω₅).

Theoretically, the local regression analysis algorithm works with a number of anatomical regions N that could be as high as one hundred or even higher. As the regression analysis is restrained to a local domain, only anatomical regions having a significant probability of contributing (through intensity diffusion) to this local domain are taken into account for the regression analysis.

Nevertheless there is a limitation that the variability of the corrected volume increases when the size of the region decreases. The theoretical limit of anatomical regions is given by the number of measurements taken into account during the local regression analysis (e.g. 27 for Ω₃, 125 for Ω₅).

Practically, the number of regions will depend on the tracer used. The method may comprise adding regions with high uptake when necessary, e.g. striatum for dopamine receptor imaging.

If regression analysis is used it may be tuned by two parameters; the size of the local domain and the Tikhonov parameter.

The structure that is the subject of the image volume may be any anatomical structure in a human or animal body and preferably one which does not move. If the anatomical structure does move the movements may be included in the point spread function. In a preferred embodiment the anatomical structure is the brain. The classes of tissue may hence include white matter, grey matter, striatum, putamen, etc. . . . The method, when used to image a brain, means that neurological conditions such as Alzheimer's disease and Binswanger's disease can be studied by looking at patterns of tracer uptake in the different regions of the brain e.g. white and grey matter, separately.

The tracer may be any tracer known to be able to be imaged by a 3D medical imaging device (for example, PET, SPECT, . . . ).

The tracer may for example be 2-deoxy-2-(18F) fluoro-D-glucose (¹⁸F-FDG). This tracer is a glucose analogue that is taken up by both grey and white matter within the brain and maps metabolic activity. It can be used to study synaptic function. This is because glucose metabolism is correlated to energy consumption supporting synaptic function. Specific regional patterns of ¹⁸F-FDG have been related to normal aging or to neurological pathologies. ¹⁸F-FDG is the most frequently used radiopharmaceutical for PET.

Another possible tracer is 99 mTc-HMPAO (hexa-jmethyl-propylene-amine-oxime). This is a radiopharmaceutical that is extracted from the blood stream an maps cerebral blood flow (perfusion imaging). It is commonly used for SPECT imaging. 99 mTc_ECD ethyl-cysteinate-dimer is another similar trace, that may also be used with the method described herein.

Further tracer types are also possible. Amyvid™ (Florbetapir F 18 Injection) is indicated for PET imaging of the brain to estimate beta-amyloid neuritic plaque density in adult patients with cognitive impairment who are being evaluated for Alzheimer's Disease (AD) and other causes of cognitive decline. The radiopharmaceutical 11C-PIB (Pittsburg compound B) labels amyeloid plaque in both gray and white matter regions of the brain. It is used to characterize the development of Alzheimers disease. ¹⁸F Flutemetamol is a related compound under development by GE Healthcare. The company is also developing DaTscan™ (Ioflupane I 123 Injection) for SPECT for use in the Diagnosis and Clinical Management of Patients with Clinically Uncertain Parkinsonian Syndrome. A large number of PET radiopharmaceuticals have been developed to accumulate on receptors in the brain (opoid-, pre- and post-synaptic dopamine-,) it is known that there is different densities of receptors in different anatomical regions of the brain. In addition, amino acids can be used to measure protein build-up in cells. One of skill in the art will appreciate that there may be many tracer types appropriate for the physiological imaging technique that is used and that the method described herein is not necessarily limited to any particular type of tracer.

The anatomical image taken for example by MRI may be segmented into regions representing as many classes of tissue as there are in the anatomical structure being imaged. For the ¹⁸F-FDG case, the anatomical image (volume) may be segmented into two classes of tissue.

Neurological diseases in the brain may be studied by patterns of tracer uptake in different regions. For example to study Alzheimer's disease it is known to determine tracer uptake in white matter regions of the brain. To be able to accurately determine the tracer uptake without the diffusion effect it is necessary to account for the effect that other classes of tissue would have on the imaged PET (the distorted image) for example due to grey matter regions.

When the anatomical structure being studied is the brain it is preferable for the two tissue types to be at least one of white matter, white matter lesions, grey matter, striatum, putamen and cerebrospinal fluid.

The method may be used to analyse white matter (WM) changes in glucose metabolism during progression from mild cognitive impairment to Alzheimer's disease. This algorithm is based on the hybrid voxel-region approach and produces voxelised volumes for further voxel-based analysis. When the algorithm is used with real ¹⁸F-FDG volumes of a brain, the correction of intensity diffusion significantly reduces the correlation between cortical gray matter uptake and subcortical white matter uptake.

In a second aspect, the present invention provides an image processing system which is configured to perform the above method of the first aspect of the invention and optionally any of the above discussed preferred features.

In a third aspect, the present invention provides an image processing system configured to perform a method of estimating the true uptake of a tracer in a physiological image acquired with a physiological image modality that has limited spatial resolution, wherein the system is arranged to: acquire a physiological image volume; acquire an anatomical image volume with an anatomical image modality of higher spatial resolution than the physiological image modality; co-register the anatomical image volume and the physiological image volume such that both image volumes have corresponding voxels; segment the anatomical image volume into a number of non-overlapping anatomical regions; combine each of the segmented anatomical regions with a function representative of the limited spatial resolution of the physiological image modality to generate a blurred anatomical region volume for each of the segmented regions; assume the physiological image in each voxel to be a linear sum of the image intensities of the corresponding voxels in the blurred region volumes; estimate for each voxel a value representative of the contribution to that voxel from each blurred region volume based on the uptake measured by the physiological image for that voxel and for nearby voxels; and use the estimated values for the voxels to estimate a true uptake of the tracer in each voxel and to thereby establish a corrected physiological image volume.

The image processing system may be arranged to carry out a method processing the image in accordance with any of the preferred features set out above.

In one example preferred embodiment, the image processing system may be configured to perform a method of compensating at a voxel level for a intensity diffusion (partial volume effect) that occurs in a positron emission tomography image of the uptake of a tracer in an anatomical structure, wherein the system is arranged to: receive an image of the anatomical structure which has been taken using magnetic resonance imaging (MRI) and which has been segmented into a number of regions, for example based on the class of tissue; receive a physiological image of the actual body part which has been taken using positron emission tomography to obtain an uncorrected image of uptake of the tracer in the anatomical structure, wherein the PET image is made up of a number of voxels; coregister the PET and MRI images; convolve the anatomical image with the point spread function of the PET scanner to produce a blurred anatomical image; estimate a distribution of activity for each region (class of tissue) in each voxel based on the tissues of neighbouring voxels; and using the estimated distribution of activity for each class of tissue of each voxel to establish a corrected PET image.

Preferably the system comprises a scanner, such as an MRI scanner, to take the anatomical image and a scanner, such as a PET scanner, to take the physiological image.

This preferred system is hence arranged to take the images itself rather than simply receiving the images from a different imaging modalities. If the system comprises a MRI scanner, the combination of MRI acquisition sequence and image processing tools should be capable of segmenting the anatomical image volume into the number of regions based on the image properties of the classes of tissue.

In a preferred embodiment the system comprises a simultaneous MRI/PET machine so that MR and PET images may be obtained simultaneously.

This simultaneity provides the advantage that the two images will be co-registered such that there is no misregistration between the first and second image when they are combined. If the two images are not imaged by the same machine there is likely to be some misregistration between the two images. Misregistration can reduce the effectiveness of the correction algorithm and thus taking the images together can avoid this problem altogether.

The invention also extends to the use of the above described method or system in the diagnosis, prognosis, treatment selection and/or treatment monitoring of patients with confirmed or suspected neurological disorder or cancer. As set out above,

In a further aspect, the present invention provides a computer program product comprising instructions that when executed on a data processing apparatus will configure the data processing apparatus to perform the method of the first aspect of the invention and optionally any of the above described preferable features.

### BRIEF DESCRIPTION OF THE DRAWINGS

Certain preferred embodiments of the present invention will now be described by way of example only with reference to the accompanying drawings.

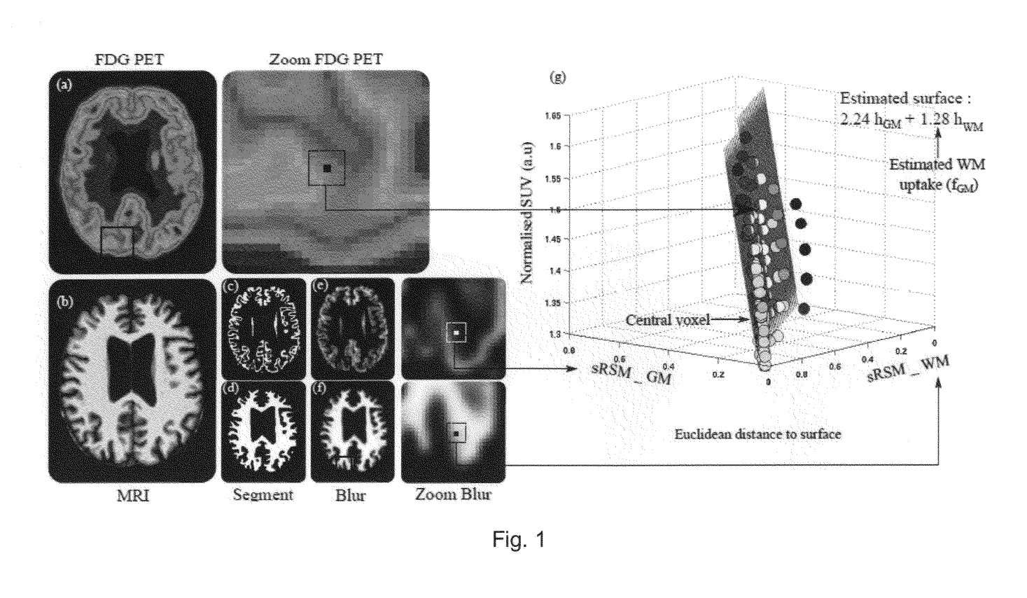

FIG. 1 shows axial in-vivo [¹⁸F]FDG PET and T1 MRI slices from one healthy subject and the processing of this data;

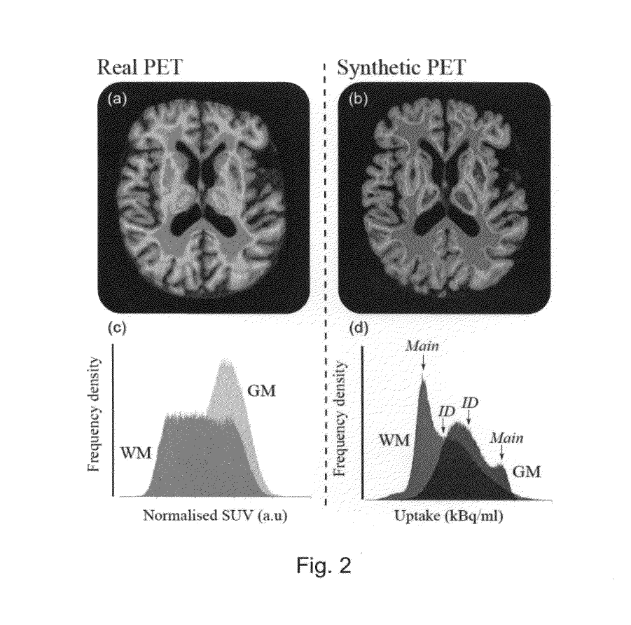

FIG. 2 shows a qualitative comparison of in-vivo PET and synthetic PET images;

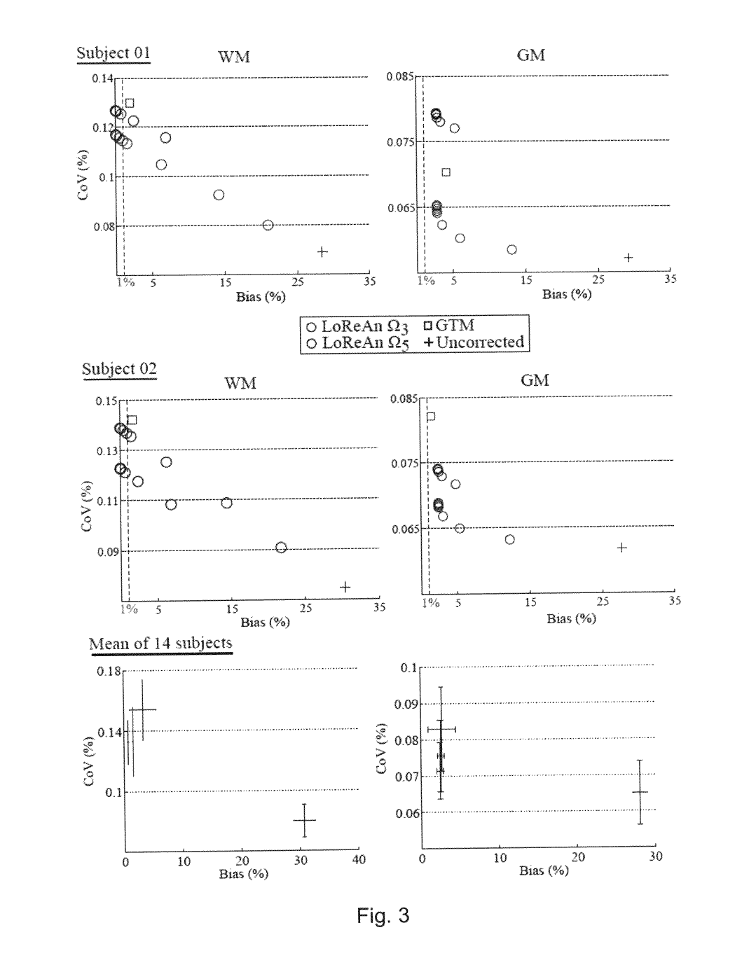

FIG. 3 shows coefficient of variation (CoV, %) plotted against the bias (%) for different values of the Tikhonov parameter;

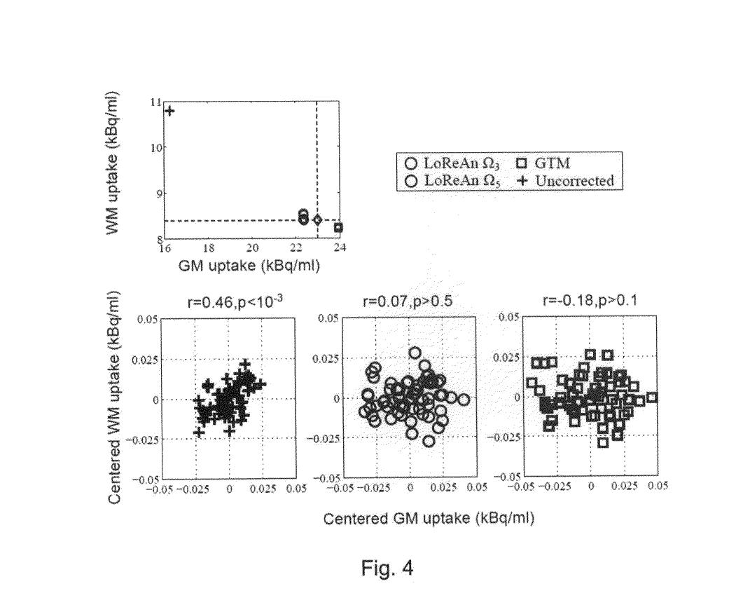

FIG. 4 shows WM uptake vs. GM uptake for 64 noisy realisations of the same MR image and centred WM uptake vs. centred GM uptake for 64 noisy realisations;

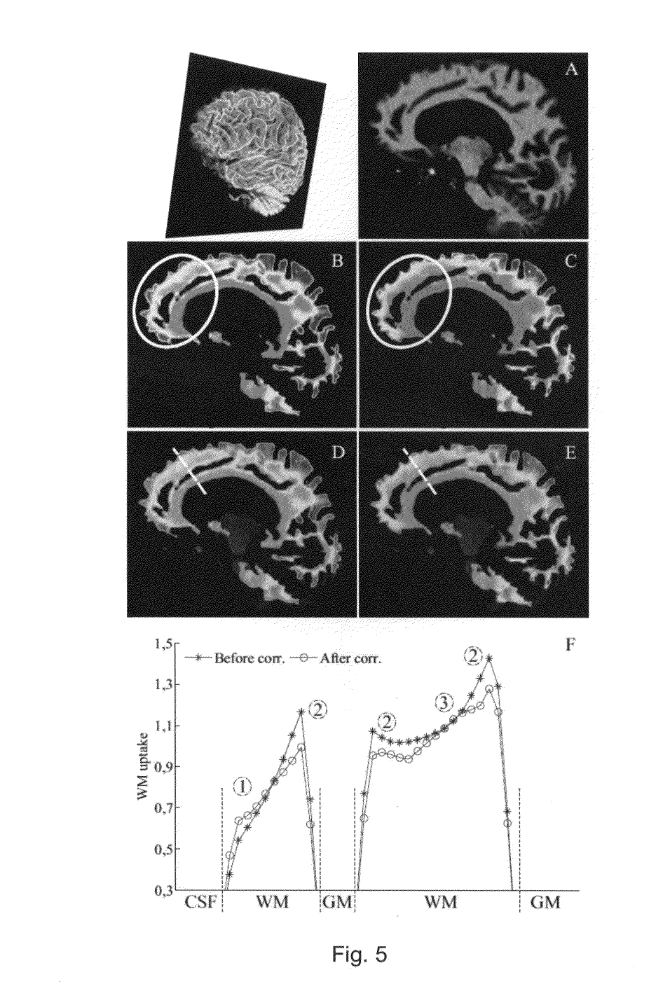

FIG. 5 shows a sagittal slice of the T1 MRI, uncorrected white matter ¹⁸F-FDG volume and local regression analysis (LoReAn) estimated white matter volume in the clinical ¹⁸F-FDG PET volumes for one healthy subject of the database;

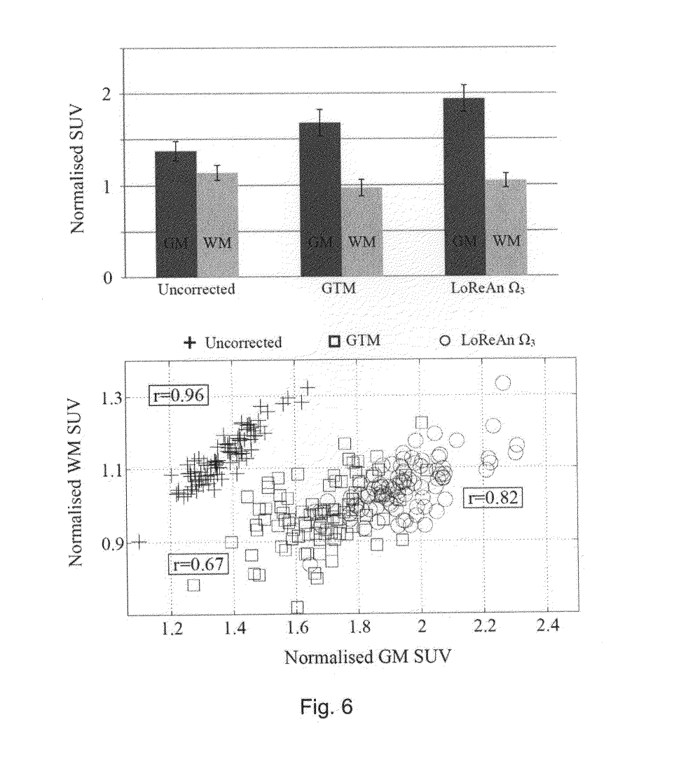

FIG. 6 shows the mean (std) normalised SUV measured in the WM and GM anatomical structures of the uncorrected volumes in 90 subjects which underwent FDG-PET and MRI examination and a scatter plot of the dataset, with each point corresponding to one subject;

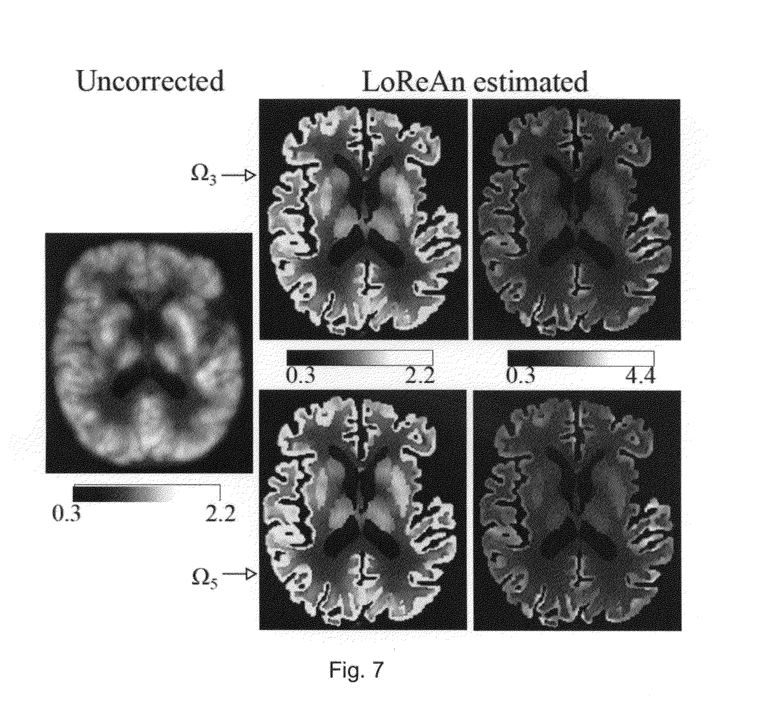

FIG. 7 shows uncorrected and LoReAn corrected volumes of one subject;

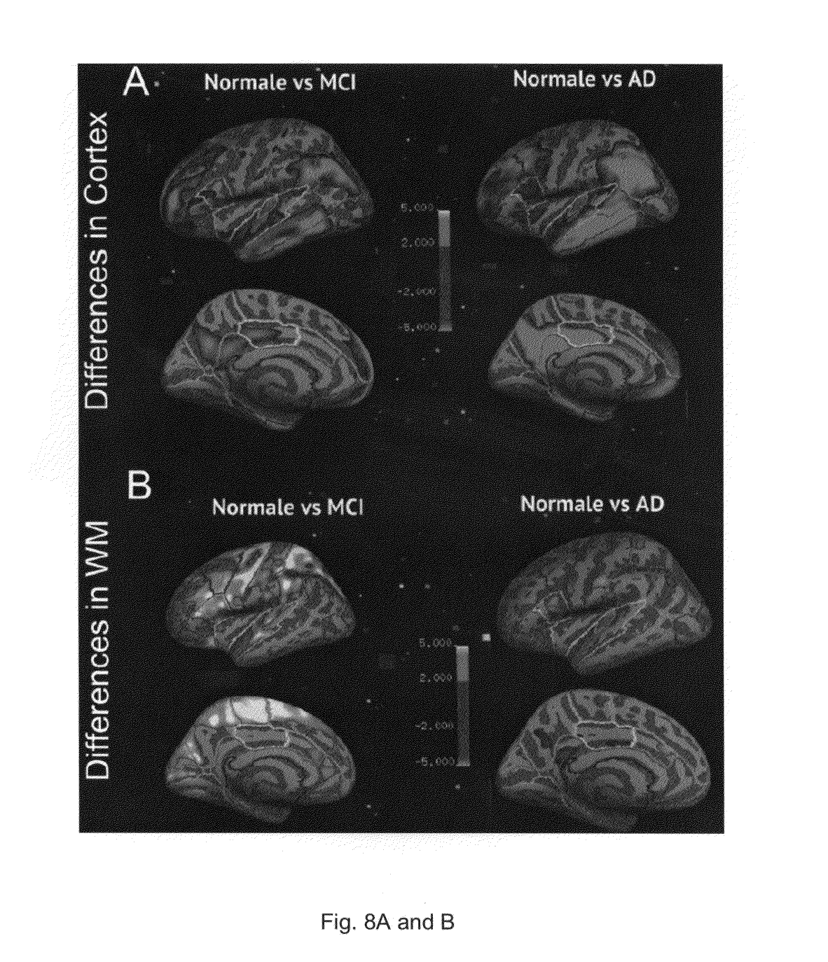

FIG. 8A shows differences in cortical FDG standard uptake value (SUV) between healthy control and MCI (left) and between healthy control and AD patients (right);

FIG. 8B shown differences in white matter FDG standard uptake value (SUV) between healthy control and MCI (left) and between healthy control and AD patients (right); and

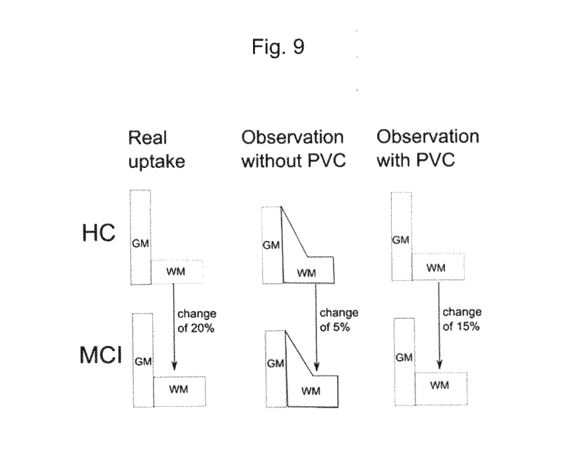

FIG. 9 shows a schematic explanation of the mechanism which hides changes in WM uptake.

### DETAILED DESCRIPTION

A preferred embodiment is shown in summary by FIG. 1. For this example the anatomical imaging is MRI and the physiological imaging is PET. FIG. 1 illustrates the case where the brain was segmented based on the MRI images into white and grey matter regions. The left column show the original physiologic (a) and anatomical images (b), which are coregistered. The small images (c) and (d) of the lower row show the segmented grey and white matter regions of the MRI image, followed by the results of blurring in (e) and (f). The blown-up cut-outs (PET on top and blurred white and grey matter in the lower part) identify a cube for which the regression analysis was carried out. The result of the regression analysis of corresponding voxels (within the cube) in the three image sets is illustrated by the 3D plot of the regression surface

g(r)=h_{GM}(r)·f_{GM}(r)+h_{WM}(r)·f_{WM}(r)+η(r) (8)

in which g(r) is plotted against the blurred region h_{GM}(r) and h_{WM}(r). The single points on which the regression analysis is based are also shown and there distance to the regression plane is colour coded.

It is known that glucose metabolism in the brain (and hence uptake of FDG) can be correlated to energy consumption supporting synaptic function and also that synaptic dysfunction and/or loss induce a reduction in neuronal energy demand that results in decreased glucose metabolism. These changes can be measured in vivo using a glucose analogue called 2-deoxy-2-(18F)fluoro-D-glucose (18F-FDG) together with a positron emission tomography (PET) scanner. Specific regional patterns of this tracer have been related to normal aging or to neurological pathologies (Mosconi, L., 2005. Brain glucose metabolism in the early and specific diagnosis of Alzheimer's disease. European Journal of Nuclear Medicine and Molecular Imaging 32, 486-510, 10.1007/s00259-005-1762-7. URL http://dx.doi.org/10.1007/s00259-005-1762-7).

Examination of glucose metabolism in the brain of patients with Alzheimer's disease (AD) can be achieved using PET.

White matter (WM) involvement has been known to occur in AD since the mid-1980s (Brun, A., Englund, E., March 1986. A white matter disorder in dementia of the Alzheimer type: a pathoanatomical study. Ann Neurol 19 (3), 253-262. URL http://dx.doi.org/10.1002/ana.410190306). Later studies have conclusively established an association between AD, vascular risk factors and indicators of vascular disease (Breteler, M. M., 2000. Vascular risk factors for Alzheimer's disease: an epidemiologic perspective. Neurobiol Aging 21 (2), 153-160.). Leukaraiosis or white matter lesions (WMLs) can be used as a surrogate marker for cerebral subcortical small vessel disease (Pantoni, L., Garcia, J. H., March 1997. Pathogenesis of leukoaraiosis: a review. Stroke 28 (3), 652-659.), one of the most common neurological disorders (Vermeer, S. E., Longstreth, W. T., Koudstaal, P. J., July 2007. Silent brain infarcts: a systematic review. Lancet Neurol 6 (7), 611-619. URL http://dx.doi.org/10.1016/S1474-4422(07)70170-9). Extensive small vessel disease may lead to subcortical vascular dementia (Binswanger's disease), but less extensive small vessel disease often coexists with AD (Snowdon, D. A., Greiner, L. H., Mortimer, J. A., Riley, K. P., Greiner, P. A., Markesbery, W. R., March 1997. Brain infarction and the clinical expression of Alzheimer disease. the nun study. JAMA 277 (10), 813-817.) and is etiologically linked to incipient AD (Stenset, V., Johnsen, L., Kocot, D., Negaard, A., Skinningsrud, A., Gulbrandsen, P., Wallin, A., Fladby, T., September 2006. Associations between white matter lesions, cerebrovascular risk factors, and low csf abeta42. Neurology 67 (5), 830-833. URL http://dx.doi.org/10.1212/01.wnl.0000234030.77831.5a and Seines, P., Blennow, K., Zetterberg, H., Grambaite, R., Rosengren, L., Johnsen, L., Stenset, V., Fladby, T., 2010. Effects of cerebrovascular disease on amyloid precursor protein metabolites in cerebrospinal fluid. Cerebrospinal Fluid Res 7, 10. URL http://dx.doi.org/10.1186/1743-8454-7-10).

A significant portion of AD patients have little or no WML, but most of these exhibit certain other vascular lesions such as cerebral amyloid angiopathy or microvascular degeneration (Kalaria, R. N., Ballard, C., 1999. Overlap between pathology of Alzheimer disease and vascular dementia. Alzheimer Dis Assoc Disord 13 Suppl 3, S115-S123.), and almost 40% of patients meeting pathological criteria for subcortical vascular dementia have accompanying AD pathology (Skoog, I., Kalaria, R. N., Breteler, M. M., 1999. Vascular factors and Alzheimer disease. Alzheimer Dis Assoc Disord 13 Suppl 3, S106-S114.). The mechanistic link between vascular disease and AD white matter affection is far from established, and white matter disease as seen in AD differs etiologically in part from that seen in vascular dementia, where changes are distributed focally and more independently of each other (Tian, J., Shi, J., Bailey, K., Mann, D. M. A., February 2004. Relationships between arteriosclerosis, cerebral amyloid angiopathy and myelin loss from cerebral cortical white matter in Alzheimer's disease. Neuropathol Appl Neurobiol 30 (1), 46-56.; and Sjöbeck, M., Haglund, M., Englund, E., May 2006. White matter mapping in Alzheimer's disease: A neuropathological study. Neurobiol Aging 27 (5), 673-680. URL http://dx.doi.org/10.1016/j.neurobiolaging.2005.03.007) and indicating that the causes of white matter disease (in the form of myelin loss) in AD are heterogeneous. Extensive examination of glucose metabolism in WM in cases of AD with and without prominent WMLs is as such warranted.

As discussed above PET imaging has a poor resolution that needs to be corrected. An essential point when studying neurological pathologies with PET is the ability to distinguish the changes of radioactivity distribution due to intensity diffusion from the true changes of tissue function (Rousset, 0. G., Zaidi, H., 2006. Correction for partial volume effects in emission tomography. URL http://dx.doi.org/10.1007/0-387-25444-7_{—}8).

To achieve this distinction, correction of the intensity diffusion is required. It is desirable to be able to correct biased uptake in different tissue types, for example subcortical white matter (scWM) regions and white matter lesions (WMLs), due to intensity diffusion. For this purpose, a new hybrid voxel-region based algorithm has been developed and implemented. In a preferred embodiment, it consists of solving the intensity diffusion problem at a voxel level by Local Regression Analysis (LoReAn) using regional information from coregistered magnetic resonance images (MRI).

The method allows changes of radioactivity distribution due to intensity diffusion from true physiological changes of tissue function to be distinguished so that a representative physiological image of each of the regions can be obtained.

The present embodiment solves the intensity diffusion problem at a voxel level by an algorithm that uses Local Regression Analysis (LoReAn) and regional information from coregistered magnetic resonance or other kinds of detailed anatomical image information.

The algorithm of a preferred embodiment consists of a two step procedure:

First, an MRI image of a brain is segmented into two or more classes of tissue. The segmentation is then combined with an accurately measured characteristics (point spread function, PSF) of the geometrical resolution of the PET scanner, i.e. the MRI images and the PET images are coregistered. This combination is used to create two or more “ideal volumes” that would result if the radiopharmaceutical had been accumulated in each region separately. Second, the measured PET volume that resulted from the PET scan is then considered to be a linear sum of these two or more “ideal volumes”:

Y=a1*X1+a2*X2+ . . . an*Xn (12)

and the objective is to estimate the ai coefficient for each class of tissue, Xi. More specifically at a local level, the ai coefficient is estimated for each volume element (voxel). To achieve this, the algorithm takes into account the PET uptake within the surroundings (neighbourhood) of each voxel. The estimation of the coefficients may be achievable by regularised regression analysis. One regression is achieved per voxel.

In other words the method combines the assumption of a linear combination of “ideal volumes” and a local approach of solving the estimation of the linear coefficients by regularised regression analysis.

For example if one is able to segment a MRI volume reliably into different regions based on the tissue types, e.g. grey matter (gm(r)) and white matter (wm(r)) regions, and assuming uniform uptake throughout the grey and white matter regions, respectively, one may form a h_{GM}(r) and a h_{WM}(r) volume by the operations:

h_{GM}(r)=gm(r) [symbol] psf(r) (6)

h_{WM}(r)=wm(r) [symbol] psf(r) (7)

where psf(r) is the point spread function model (e.g. Gaussian kernel). Under this hypothesis, any voxel of the measured distribution of activity (the FDG-PET volume) can be described as the weighted sum of the contribution of the two regions of uniform uptake:

g(r)=h_{GM}(r)·f_{GM}(r)+h_{WM}(r)·f_{WM}(r)+η(r) (8)

If the uptake in the two tissue regions were uniform throughout the entire anatomical structure, the two parameters f_{GM}(r) and f_{wm}(r) would also be uniform throughout the brain, and represent a global ratio between the uptake in the two classes of tissue. However, the algorithm assumes that the two parameters vary according to the local function of the tissues, and therefore f_{GM}(r) and f_{wm}(r) needs to be estimated for each voxel r of the volume. This estimation is performed by sliding a fixed cubic region over the volume and computing f_{GM}(r) and f_{WM}(r) for the central voxel by regression analysis using voxels in the neighbourhood of r:

$$\hat{f} ( r ) = {min}_{f ( r )} \{ {‖ h ( r ) f ( r ) - g ( r ) ‖}^{2} \} \qquad ( 10 )$$

∥•∥ being the 2-norm of the vector. The underlying assumption is that f_{GM}(r) and f_{wm}(r) are slowly varying within the neighbourhood. FIG. 1 shows an example of the estimation of f_{GM}(r) and f_{WM} (r) from real patient data, which defines a plane passing through zero, using a neighbourhood of 5×5×5 voxels around the central voxel.

FDG examples: FIG. 1 shows axial in-vivo [¹⁸F]FDG PET and T1 MRI slices from one healthy subject (FIGS. 1(a) and 1(b) respectively). The MRI volume is parcellated using probability segmentation and these labels are gathered to create three binary volumes: GM in FIG. 1(c), WM in FIG. 1(d) and CSF (not shown). Using the experimentally estimated PSF, the binary volume is blurred FIGS. 1(e) and (f) to create an independent probability emission map (IPEM) that is used as explanatory variable in the linear model. PET voxel values within a restrained neighbourhood are modelled as a linear combination (g) of IPEMs (here, GM and WM) and the estimated coefficient is considered to be the corrected value for the central voxel of the neighbourhood of 5×5×5 voxels.

Generalising the example to N regions, a cubic domain in the image volume is considered as:

$${Ω}_{c}^{i , j , k} = \{ ( x , y , z ) \vert i - \tilde{c} \leq x \leq i + \tilde{c} , j - \tilde{c} \leq y \leq j + \tilde{c} , k - \tilde{c} \leq z \leq k + \tilde{c} \} \\ with \tilde{c} = \frac{( c - 1 )}{2} \qquad ( 13 )$$

As defined, Ω_{c}^{i,j,k} is centred in voxel (i, j, k) and contains c×c×c voxels. If s segmented regions with assumed uniform uptake are defined on the measured activity volume g, one can rewrite the equation above in the domain Ω_{c}^{i,j,k}:

g_{i,j,k}=H_{i,j,k}·f_{i,j,k}+η_{i,j,k} (14)

where H_{i,j,k} is a c³×s matrix containing, for each region, the probability value that voxel (x, y, z) εΩ_{c}^{i,j,k} has diffused onto voxel (i, j, k), f_{i,j,k} is a s×1 vector of the estimated contribution of each region to the true radioactivity in voxel (i, j, k), η_{i,j,k} is a c³×1 vector of the uncorrelated noise and finally g_{i,j,k} is a c³×1 vector of the measured activity concentration in (x, y, z) εΩ_{c}^{i,j,k}

The objective is to estimate f_{i,j,k} for each voxel of the volume. Considering ρ_{i,j,k} as the c³×c³ covariance matrix of the uncorrelated noise, the weighted least-square solution (Saporta, G., 2006. Probabilité, Analyse des données et Statistique. Technip.) of the linear model is (dropping the subscript _{i,j,k} for more clarity):

\hat{f}=(H^{T}ρ⁻¹H)⁻¹H^{T}ρ⁻¹g (15)

The problem with using the least squares solution is that small changes in the data can cause arbitrarily large changes in the solution (Hansen, P. C., O'Leary, D. P., 1993. The use of the I-curve in the regularization of discrete ill-posed problems. SIAM Journal on Scientific Computing 14 (6), 1487-1503. URL http://link.aip.org/link/?SCE/14/1487/1).

The use of a regularisation algorithm is often used to limit the increase of variability in the solution. The Tikhonov regularization is the most common method. When implemented, the minimisation problem of Equation (10) is modified by the introduction of a second term:

$${min}_{f ( r )} \{ {‖ h ( r ) f ( r ) - g ( r ) ‖}^{2} + λ {‖ f ( r ) ‖}^{2} \} \qquad ( 11 )$$

The parameter λ controls how much weight is given to minimization of ∥f(r)∥ relative to minimization of the residual norm. Taking into account the regularization term in Equation (15), the equation to solve becomes:

\hat{f}=(H^{T}ρ⁻¹H+λI_{c}_{³})⁻¹H^{T}ρ⁻¹g (16)

where I_{c3} is the c³×c³ identity matrix. Equation (16) will be solved for all n voxels of the PET volume, leading to s volumes, one per segmented region. As a given voxel belongs only to one segmented region, \hat{f}_{LoReAn} is created by assigning to a voxel the value of the region it belongs to.

The key step of this algorithm is to obtain an accurate description of H. A precise measurement of the point spread function (PSFₑₛₜ) of the acquisition process (as described later) gives the probability that the uptake in voxel (x, y, z) diffuses into the voxel (i, j, k). A precise segmentation of the coregistered MRI volume allows a segmentation of the s classes of tissue in the brain. Finally, the matrix H can be filled up column by column: the binary map of the s segmented regions is convolved with the PSF of the image formation process, resulting in a blurred volume with values between 0.0 and 1.0 that would describe the diffusion process for the s regions.

To evaluate the algorithm of the preferred embodiment, synthetic ¹⁸F-FDG PET volumes were created from parcellated MR volumes. In addition, a dataset of real ¹⁸F-FDG PET volumes with segmented and coregistered MR volumes were used to validate the feasibility of such algorithm on clinical data. The focus of the study was given to the correction of the subcortical white matter regions.

Synthetic ¹⁸F-FDG volumes were used in this study in order to have the full control over the true regional activity. As a result, the accuracy and variability of the estimated activity could be measured after correction from intensity diffusion with both the known GTM and the LoReAn algorithm.

The MR volumes of the dataset were parcellated according to procedures described by Fischl (Fischl, B., van der Kouwe, A., Destrieux, C., Halgren, E., Ségonne, F., Salat, D. H., Busa, E., Seidman, L. J., Goldstein, J., Kennedy, D., Caviness, V., Makris, N., Rosen, B., Dale, A. M., January 2004. Automatically parcellating the human cerebral cortex. Cerebral Cortex 14 (1), 11-22. URL http://dx.doi.org/10.1093/cercor/bhg087). Based on this parcellation, three sets of anatomical structures were created (GM, WM, CSF) by gathering regions that have been shown to have uniform uptake with ¹⁸ F-FDG. Each anatomical structure was given an activity value (in this case the assigned values were as follows: GM: 22.99 kBq/ml, WM: 8.45 kBq/ml and CSF: 0 kBq/ml) and all anatomical structures were gathered in one volume. This noise-free volume was contaminated with a randomly generated noise component (Gaussian distribution, μ=g(r), a σ=sqrt(6 g(r))). Finally, the noisy volume was subsequently convolved with an isotropic 3D Gaussian kernel (PSF_{eff}) characterised by its full width at half maximum (FWHM=5.12 mm×5.9 mm×5.9 mm). By applying the blurring step last in the synPET volume creation, the noise becomes correlated, increasing the similitude (at least in term of noise level and properties) with real PET volumes. Table 1 reports, for the whole dataset, the mean signal-to-noise ratio (SNR) in the GM and WM of the real and synthetic PET volumes, quantifying the similarity in the noise level between synthetic and real data.

TABLE 1
Mean (±std) signal-to-noise ratio (SNR) of the measured
values in the gray matter (GM) and white matter (WM) anatomical
structures for the real PET and the synthetic PET volumes
across the whole dataset (N = 90). The GM and WM anatomical
structures were defined using coregistered labels.

| | GM | WM |
|---|---|---|
| Real PET | 5.29 ± 0.58 | 3.32 ± 0.30 |
| Synthetic PET | 5.24 ± 0.29 | 4.17 ± 0.10 |

In parallel, fourteen healthy subjects were extracted from the dataset. For each of them, the previous procedure was achieved 64 times with only the noise component changing, creating a set of structurally similar but statistically different volumes to test intensity diffusion correction algorithms.

As the synthetic FDG-PET is derived from the parcellation of the MRI, no coregistration error initially existed between each synthetic FDG-PET volume and the MRI volume.

FIG. 2 shows a qualitative comparison of the in-vivo PET (a,c) and synthetic PET (b,d). (a) shows an overlay of axial in-vivo [¹⁸F]FDG PET and MRI slices. (b) shows an overlay of axial synthetic [¹⁸F]FDG PET and MRI slices, (c) is a histogram of GM and WM voxels from the in-vivo [¹⁶F]FDG PET volume. (d) is a histogram of GM and WM voxels from the synthetic [¹⁸F]FDG PET volume. Main points towards the values corresponding to the initial assign activity, ID points towards the values being caused by intensity diffusion.

To test the algorithm in the ideal case, synthetic ¹⁸F-FDG PET volumes have been created using the framework previously described. For each volume, the GTM estimation values and the LoReAn estimation volume have been calculated using the GM, the WM and the CSF as regions with uniform uptake. The PSFₑₛₜ was considered perfectly estimated and taken equal to PSF_{eff}.

To test the robustness of the estimation with respect to registration error, a rigid displacement of the whole volume of 1 mm or 2 mm was induced either along the z-axis or along the three axis simultaneously (x-axis, y-axis and z-axis). As for the ideal case, synthetic ¹⁸F-FDG PET volumes have been created and the PSFₑₛₜ was considered perfectly estimated and taken equal to PSF_{eff}.

For clinical tests subjects were extracted from a project database. After excluding volumes with major anatomical abnormalities (extended ventricles, major stroke), eighty-nine subjects were included in this study. All coregistrations between PET and MRI volumes and segmentation of the MRI volume were visually inspected before being included in the study.

T1w MRI images were achieved in two different sites (Aker University Hospital and The Norwegian Radium Hospital, now part of Oslo University Hospital). Both sites used a 1.5 T scanner from Siemens Medical Systems. Using the same subjects on both scanners, Fjell et al. (2008) showed that change between both scanners introduced cortical thickness differences within ±0.1 mm across the cortex.

¹⁸FDG-PET scans were achieved in one site (The Norwegian Radium Hospital, Oslo) by use of the Biograph 16 PET/CT scanner (Siemens). All patients were fasted at least four hours before the acquisition. Subjects had an intravenous bolus of 218 MBq (±23 MBq) injected and rested for forty five minutes after the injection. Patients were positioned in head-first supine (HFS) in the scanner. Prior to the PET acquisition, a low-dose CT scan was acquired, to be used for attenuation correction. Patients were scanned for fifteen minutes in three dimensional mode. Acquired data were corrected for random events, dead time, attenuation (CT-derived μ-map), scatter (model based) and decay time. PET volumes were reconstructed using an iterative algorithm (OSEM 2D, 4 iterations, 8 subsets), and a post-reconstruction 3D Gaussian filter of width 3.5 mm full-width at half maximum (FWHM) was applied. The axial image format was 256×256 (pixel size: 2.67 mm×2.67 mm), with a slice thickness of 2.00 mm.

The method for determining the effective Gaussian point spread function has been published earlier (Skretting, A., April 2010. A method for on-site measurements of the effective spatial resolution in pet image volumes reconstructed with osem and gaussian post-filters. Radiation Protection Dosimetry 139 (1-3), 195-198. URL http://rpd.oxfordjournals.org/content/139/1-3/195.abstract). Briefly, it consists in a) acquisition of the line spread functions in three directions using a thin tube filled with ¹⁸F, b) normalization to form integrals=1.0, c) building of spatial cumulative functions at each pixel border and c) fitting of the Gaussian cut-off values obtained for each of the cumulative values to the corresponding left pixel border coordinates by regression analysis. The Gaussian cut-off value x is given in terms of the number of standard deviations up to the point where the probability of finding a free variable above x is equal to the actual cumulative function. The angular coefficient of the regression line is the inverse of the spatial standard deviation of the underlying Gaussian.

T1-weighted MRI. MR skull striping and segmentation were performed using Freesurfer 4.4.0 (http://surfer.nmr.mgh.harvard.edu/). The cortical surface was parcellated according to procedures described by Fischl et al. Anatomical region of interests (ROIs) corresponding to gray matter were gathered to form one anatomical GM region. The same gathering was achieved for anatomical ROIs corresponding to white matter and to CSF.

¹⁸F-FDG PET volumes were transformed from DICOM to Nifti format. Data were corrected voxel-wise for subject's weight and injected dose, and standard uptake value (SUV) maps were calculated. Intra-subject spatial alignment between functional ¹⁸F-FDG PET and scalp-edited T1w images were achieved. Following Kiebel et al. (Kiebel, S. J., Ashburner, J., Poline, J. B., Friston, K. J., May 1997. MRI and PET coregistration—a cross validation of statistical parametric mapping and automated image registration. Neuroimage 5 (4 Pt 1), 271-279. URL http://dx.doi.org/10.1006/nimg.1997.0265), a 6-parameter rigid body spatial registration was performed using the Spatial Parametrical Mapping (SPM 8, Wellcome Trust Centre for Neuroimaging, UCL, UK) coregistration tool. Translational and rotational error could be expected to be less than 1 mm and 0.6 degrees respectively (Kiebel et al. (1997)). PET volumes were re-sliced into 1 mm MRI space using a spline interpolation.

Finally, for each subject, a voxel-based normalization to the mean uptake in the brain stem was performed. In order to discard segmentation, co-registration and intensity diffusion artefacts, mean uptake of the brain stem was calculated using an eroded map of the brain stem (cubic kernel of 6 mm). Normalised SUV (nSUV) volumes are further used for the analysis.

To compare the algorithms, four figures of merit, inspired by the work of Rahmim (Rahmim, A., Zhou, Y., Tang, J., Lu, L., Sossi, V., Wong, D. F., 2012. Direct 4d parametric imaging for linearized models of reversibly binding pet tracers using generalized ab-em reconstruction. Physics in Medicine and Biology 57 (3), 733. URL http://stacks.iop.org/0031-9155/57/i=3/a=733), have been calculated for three region-of-interests (ROI): the regional bias (Bias_{ROI}, %), the standard deviation (STD_{ROI}), the coefficient of variation (COV_{ROI}, %) and the Pearson's correlation coefficient.

The Bias_{ROI} for a given ROI of known true activity (f_{ROI}) was defined as:

$${Bias}_{ROI} = 100 \% \times \frac{\vert {\hat{f}}_{ROI} - {f}_{ROI} \vert}{{f}_{ROI}} \qquad ( 17 )$$

where \hat{f}_{ROI} is the overall mean ROI uptake. The STD_{ROI} was constructed to measure the variations of the overall mean ROI uptake with the noise (or subject) realisations. Calling the mean ROI uptake of the n^{th} realisation (or subject),\hat{f}_{ROI}ⁿ STD_{ROI} was defined as following:

$${STD}_{ROI} = \sqrt{\frac{1}{N} {\sum }_{n = 1}^{N - 1} {( {\hat{f}}_{ROI}^{n} - {\hat{f}}_{ROI} )}^{2}} \qquad ( 18 )$$

where N is the total number of noise realisations (or subjects). Finally, the coefficient of variation (COV_{ROI}) of a given ROI was defined as:

$${COV}_{ROI} = 100 \% \times \frac{{STD}_{ROI}}{{\hat{f}}_{ROI}} \qquad ( 19 )$$

The Pearson's correlation coefficient was used as a relative degree of intensity diffusion in the volumes. The correlation coefficient along subjects between two regions A and B is expressed as:

$$r ( A , B ) = \frac{{\sum }_{i = 1}^{n} ( {A}_{i} - \overline{A} ) ( {B}_{i} - \overline{B} )}{\sqrt{{\sum }_{i = 1}^{n} {( {A}_{i} - \overline{A} )}^{2}} \sqrt{{\sum }_{i = 1}^{n} {( {B}_{i} - \overline{B} )}^{2}}} \qquad ( 20 )$$

where n is the number of subjects, Aᵢ and Bᵢ are the mean value in region A and B for subject i, and Ā and B̅ are the mean value in region A and B along subjects

For each iteration or subject, the mean uptake value has been measured in the two set of regions (cortical GM and subcortical WM) for the uncorrected ¹⁸F-FDG PET volume and for the LoReAn estimated volume. The correlation coefficient between cortical GM and subcortical WM is calculated for these two series.

In the ideal case, the mean coefficient of variation (CoV) and bias calculated for the white matter (WM) and gray matter (WM) anatomical structures of the uncorrected volumes, the GTM estimated values and the LoReAn estimated volumes are reported in FIG. 3. FIG. 3 shows the coefficient of variation (CoV, %) plotted against the bias (%) for different values of the Tikhonov parameter (λ=10⁻⁴; 5*10⁻⁴; 10⁻³; 5*10⁻³; 10⁻²; 5*10⁻²; 10⁻¹; 5*10⁻¹; 10°). Uncorrected (+), GTM-corrected (□) and LoReAn-corrected (◯) values are reported in each graph. The CoV and bias have been obtained in the whole WM (left hand graphs) and the whole GM (right hand graphs) by averaging 64 noisy realisations for different segmented MR images.

Top and middle rows are results of two subjects out of the fourteen, whereas the bottom row represents the mean and standard deviation of the CoV and bias for the 14 subjects. The top and middle rows illustrate two out of the fourteen subjects, whereas the bottom row illustrates the mean and standard deviation of the CoV and bias calculated out of the fourteen subject's datasets (out of each of the fourteen subjects a 64 volumes dataset with different noise realisations was calculated). The CoV and the bias have been calculated for the LoReAn estimated volumes with increasing values of the Tikhonov parameter (λ=(5*10⁻³, 10⁻², 2.5*10⁻², 5*10⁻², 7.5*10⁻², 10⁻¹, 2.5*10⁻¹, 5*10⁻¹, 10°)) and for two different sizes of local domain (3×3×3 mm³ (Ω₃) and 5×5×5 mm³ (Ω₅)).

In FIG. 4 the top graph shows WM uptake vs. GM uptake for 64 noisy realisations of the same MR image. Uncorrected (+), GTM-corrected (□) and LoReAn-corrected (◯) values are reported. The noise-free ideal solution is also plotted (⋄). The bottom graph shows centred WM uptake vs. centred GM uptake for 64 noisy realisations. Correlation coefficients between GM and WM are reported for uncorrected (left), LoReAn-corrected (centre) and GTM-corrected (right) measures.

In the top figure of FIG. 4, the mean uptake of the WM and GM anatomical structures of the uncorrected volumes, the GTM estimated values and the LoReAn estimated volumes of one subject are reported with two different sizes of local domain, together with the original noise-free uptake level assigned to WM and GM anatomical structures. For the same subject, the bottom graph of FIG. 4 reports the correlation induced by the presence of intensity diffusion and how the correction algorithms reduce this correlation. To illustrate this effect, the centred (mean subtracted from each noisy realisation) uptakes of WM and GM anatomical structures for the 64 noisy realisations are plotted without correction (left: r(64)=0.46, pᵢ10⁻³) showing the introduction of a significant correlation when modelling intensity diffusion. The GTM estimated values show decreased correlation between WM and GM anatomical structures (right: r(64)=−0.18, p [symbol] 0.1) and the mean uptake measured in the GM and WM anatomical structures of the LoReAn estimated volumes shows even lower correlation (canter: r(64)=0.07, p [symbol] 0.5).

The mean bias (CoV not reported) calculated in the WM (Tab. 2) and GM (Tab. 3) anatomical structures of the uncorrected volumes, the GTM estimated values and the LoReAn estimated volumes are reported in the ideal case and in presence of misregistration for one subject.

TABLE 2
Bias (%) measured in the GM anatomical structure of the synPET
volumes when applying increased misregistration error (0, 1 and
2 mm) along the Z-axis (Z) or along the X, Y and Z-axis (XYZ).
The misregistration is applied to the segmented MR volume.

| | | | 1 mm, | 1 mm, | 2 mm, | 2 mm, |
|---|---|---|---|---|---|---|
| | | 0 mm | Z | XYZ | Z | XYZ |
| DEH014 | Uncorrected | 29.2 | 30.3 | 32.5 | 32.9 | 38.7 |
| | GTM | 4.1 | 2.5 | 1.3 | 1.6 | 12.5 |
| | LoReAn | 2.8 | 4.5 | 8.1 | 7.9 | 17.0 |

TABLE 3
Bias (%) measured in the WM anatomical structure of the synPET
volumes when applying increased misregistration error (0, 1 and
2 mm) along the Z-axis (Z) or along the X, Y and Z-axis (XYZ).
The misregistration is applied to the segmented MR volume.

| | 0 mm | 1 mm, Z | 1 mm, XYZ | 2 mm, Z | 2 mm, XYZ |
|---|---|---|---|---|---|
| Uncorrected | 28.5 | 29.2 | 31.3 | 30.3 | 35.0 |
| GTM | 2.0 | 0.14 | 4.5 | 4.2 | 15.8 |
| LoReAn | 0.15 | 3.9 | 10.1 | 10.4 | 25.5 |

Misregistration consisted in displacing the anatomical MR volume after the creation of the synPET volume so that MR and synPET volumes were displaced of a desired level. Four levels of misregistration were applied: 1 mm along the Z axis, 1 mm along the three axes (XYZ), 2 mm along the Z axis and finally 2 mm along the three axes.

In the clinical ¹⁸F-FDG PET volumes, sagittal slice of the T1 MRI (A), uncorrected white matter ¹⁸F-FDG volume (B) and LoReAn estimated white matter volume (C) are shown in FIG. 5 for one healthy subject of the database. Line profiles along the WM for the previously mentioned volumes (F) are drawn in the same figure (F), providing an example of the effect of the algorithm on estimated WM uptake when situated in a boundary between CSF and WM regions (F,1), a boundary between GM and WM regions (F,2) and within the WM region (F,3).

The mean (std) normalised SUV measured in the WM and GM anatomical structures of the uncorrected volumes, the GTM estimated values and the LoReAn estimated volumes has been measured in 90 subjects and are reported in the top figure of FIG. 7. The difference between the two anatomical regions are significant before correction, but becomes more significant when using GTM correction or LoReAn correction. The bottom figure of FIG. 7 represents the scatter plot of the dataset, with each point corresponding to one subject. The global correlation between these measures dropped from r(90)=0.90 (p=10⁻⁵⁰) with the uncorrected volumes to r(90)=0.66 (p=10⁻²⁰) with the LoReAn estimated volume and r(90)=0.45 (p=10⁻¹⁰) with the GTM estimated values. There is still a statistical significant correlation between GM and WM SUV with the LoReAn estimated volume, but with a clearly weaker strength than with the uncorrected volume.

The above provides an example of using the algorithm to analyze white matter (WM) changes in glucose metabolism during progression from MCI to AD. Compared to the actual state-of-the-art algorithm, the Local Regression Analysis (LoReAn) algorithm of the preferred embodiment was hypothesized to be similar in term of bias in the ideal case and in presence of misregistration. In addition, the algorithm, based on a hybrid voxel-region approach, has produced voxelized volumes for further voxel-based analysis. Using this algorithm in the preferred embodiment with real ¹⁸F-FDG volumes, the correction of intensity diffusion has significantly reduced the correlation between cortical gray matter uptake and subcortical white matter uptake. Several points related to these findings are discussed below.

The regression analysis is tuned by two parameters: the size of the local domain and the Tikhonov parameter.

Two sizes of domain (3×3×3 mm³ (Ω₃) and 5×5×5 mm³ (Ω₅)) have been tested, chosen in relation to the FWHM of the PSF_{eff} of the synPET (5 mm) and the measured FWHM of the scanner (5.9×5.9×5.12 mm³). A larger local domain will be less prone to instability due to noisy data, but on the other hand, details of the size of the domain or smaller will be smoothed, risking the loss of some information. In addition, the cortical ribbon has a mean width of 2-3 mm, which is already smaller than the Ω₅ domain. At this stage, the choice of one or other size depends on the type of analysis done after the correction (voxel vs. regional).

The choice of the Tikhonov parameter has been made visually by testing different values and plotting an “‘L-curve’” representing the noise versus the bias (FIG. 3).

Standard deviation of the mean normalised SUV (STD_{SUV}) was measured for the whole WM (left) and GM (right) regions in 90 subjects that underwent FDG-PET and MRI examination. Uncorrected volumes (+), GTM-estimated values (□) and LoReAn-estimated volumes with increasing values of Tikhonov parameters (◯) are reported. λ=10⁻⁴; 5*10⁻⁴; 10⁻³; 5*10⁻³; 10⁻²; 5*10⁻²; 10⁻¹; 5*10⁻¹; 10⁰.

The optimal value for the parameter is dependant on the quantity of noise in the volume but quite independent of the anatomical structure (see subject 1 and 2 of FIG. 3). This means that the parameter could be calibrated once with a phantom study and would not need any further tuning each time it is used.

Theoretically, the LoReAn algorithm works with a number of anatomical regions N that could be as high as one hundred. As you restrain the regression analysis to a local domain, only anatomical regions having a significant probability of diffusing within this local domain are taken into account for the regression. Nevertheless there is a limitation as mentioned previously for the other region-based correction methods: the variability of the corrected volume increases when the size of the region decreases. The theoretical limit of anatomical regions is given by the number of measurements taken into account during the local regression analysis (27 for Ω₃, 125 for Ω₅). Working with a high number of regions lowers the degrees of freedom of the regression analysis. As a consequence, the variability is not correctly estimated. Practically, the number of regions will depend on the radiotracer used, adding regions with high uptake when necessary, e.g. striatum for dopamine receptor imaging.

In an ideal setting (no misregistration which is achieved with the synthetic data), the LoReAn estimated volume was almost unbiased (0.15% in WM, 2.8% in GM), and gave better results compared to the GTM estimation (2% in WM, 4.1% in GM). The bias measured with the GTM estimation corresponds to previous reports (Frouin, V., Comtat, C., Reilhac, A., Grégoire, M.-C., December 2002. Correction of partial-volume effect for pet striatal imaging: fast implementation and study of robustness. J Nucl Med 43 (12), 1715-1726. URL http://jnm.snmjournals.org/content/43/12/1715). Furthermore, finding such accurate recovery coefficients is not unusual, and some recent intensity diffusion algorithms have reported bias values as close from zero as the present study (Shidahara, M., Tsoumpas, C., Hammers, A., Boussion, N., Visvikis, D., Suhara, T., Kanno, I., Turkheimer, F. E., January 2009. Functional and structural synergy for resolution recovery and partial volume correction in brain pet. Neuroimage 44 (2), 340-348. URL http://dx.doi.org/10.1016/j.neuroimage.2008.09.012; and Thomas, B., Erlandsson, K., Modat, M., Thurfjell, L., Vandenberghe, R., Ourselin, S., Hutton, B., 2011. The importance of appropriate partial volume correction for pet quantification in Alzheimer's disease. European Journal of Nuclear Medicine and Molecular Imaging 38 (6), 1104-1119. URL http://dx.doi.org/10.1007/s00259-011-1745-9). In addition, FIG. 3 shows that the variability of the LoReAn estimated volume is lower than the GTM estimated values.

When introducing misregistration (Tab. 2 and 3), the bias increases both with GTM and LoReAn, but with a higher level for the latter one. This is due to the fact that the LoReAn algorithm works at the voxel level, whereas the GTM averages through the whole region before inverting the matrix, being less sensitive to misregistration errors. The evolution of the bias with the GTM algorithm could be somehow unexpected, showing more accurate results with 1 mm misregistration than without. This evolution has been previously reported by Frouin (FIG. 5-7 in Frouin et al. (2002)) without any clear explanation. These results have also to be moderated by the fact that misregistration errors between FDG-PET images and MR images are seldom superior to the millimetre (Kiebel et al., 1997) with current registration algorithms. However, simultaneous PET/MR machines will provide perfectly registered images which could take advantage of the described algorithm.

With the real data, correlations reported between the mean gray matter and the mean white matter normalised SUV decreased substantially after using the LoReAn algorithm (FIG. 6, bottom). As the synthetic PET study showed, correlation measurements are a valid criteria to evaluate the level of intensity diffusion. However, a physiological correlation exists between GM and WM glucose metabolism, explaining the still significant level of correlation, both with LoReAn and GTM. In addition to correcting from intensity diffusion, a decreased variability of the mean normalised SUV is observed in FIG. 6 for the white matter region compared to the uncorrected volume and the GTM estimated values.

FIG. 7 shows uncorrected (left) and LoReAn-corrected (centre and right) volumes of one subject. For comparison purposes, the central column is represented with the same colour range as the uncorrected volume, whereas the colour range is doubled in the right column. This Figure shows that regions of the brain where intensity diffusion is not important (deep white matter, striatum) are left untouched by the algorithm. However, the effect of the algorithm can be clearly seen in subcortical white matter where the level of uptake is greatly reduced. Nevertheless, one of the actual limitation of the LoReAn algorithm can also be seen in the right column of FIG. 7 which shows abnormally high level uptake in the cortical ribbon. This effect exists because of the spill-out signal in the skull that is not taken into consideration by including an extra region defining the surroundings of the brain. When including such region, this aberrant high level voxels disappear.

This disclosure describes a voxel-based algorithm to correct for intensity diffusion in FDG-PET volumes in at least the preferred embodiment. Tested both on synthetic and real data, it shows beneficial results in term of bias correction and noise level of the FDG-PET uptake in the white matter region.

An example of an embodiment of the present invention being used on real data is set out below.

One of the physiological consequences of AD is neuronal loss which can be monitored by looking at blood flow or glucose metabolism changes. Changes in glucose metabolism could be measured by means of FDG PET imaging. It has been described in several studies that cortical uptake of FDG decreases throughout the development of the disease from a healthy control, to mild cognitive impairment, to Alzheimer's Disease (HC->MCI->AD). One problem encountered is that the MCI group has a great variability. Other markers differentiating MCI from HC would therefore be of great benefit. For this purpose, changes in FDG uptake in WM regions was investigated.

### Material and Methods

109 subjects (HC:45, MCI:28, AD:36) extracted from the Alzheimer's Disease Neuroimaging Initiative (ADNI) database were used in this study. Each individual had a brain FDG-PET and an anatomical brain MRI. The MRI scans were parcellated (Freesurfer) into several volumes of interests (VOIs) (mainly cortical, subcortical and WM regions) i.e. the anatomic images were segmented into a number of anatomical regions. Brain FDG-PET scans were transformed in standard uptake values (SUV), normalised to the pons uptake (nSUV) and spatially normalised to the anatomical MRI in order to use the VOI to measure average nSUVs in different regions of the brains. In addition, partial volume correction (PVC) using the LoReAn algorithm (according to an embodiment of the present invention) was applied to avoid biasing the low-level WM signal with the high-level cortical signal. Finally, specific methodology allowed us to measure the average nSUVs at different depths of the WM: WM (1 mm) means it is the average signal in the WM region at 1 mm from the GM/WM border.

### Results

It was found that when looking at the cortical uptake, that significant differences in FDG nSUV between healthy control and MCI (left of FIG. 8A) and between healthy control and AD patients (right of FIG. 8A) were measured. The typical pattern of medial temporal and occipital lobe decrease FDG uptake confirms that the population selection and methodology reproduces well-established results. Interestingly, differences in white matter FDG standard uptake value (SUV) between healthy control and MCI (left of FIG. 8B) and between healthy control and AD patients (right of FIG. 8B) were found. Each of the FDG PET images have been corrected for PVC using the LoReAn algorithm (according to an embodiment of the present invention). Significant increase of FDG uptake in early dementia stages (MCI) was measured. This increase in the MCI group could be explained by increase in blood flow resulting from a deregulation of the microvasculature. It is important to note that, no significant difference between healthy control and MCI could be measured without using the LoReAn algorithm. Indeed, when no correction is used, the WM uptake measured is strongly correlated (biased) by the cortical uptake, hiding the changes in WM uptake.

FIG. 9 provides a schematic explanation of this mechanism which hides the changes in WM uptake.

In conclusion, the LoReAn algorithm (according to an embodiment of the present invention), permits differences in WM FDG uptake to be measured between HC and MCI patient groups.

1. A method of estimating the true uptake of a tracer in a physiological image acquired with a physiological image modality that has limited spatial resolution, the method comprising:
acquiring a physiological image volume;
acquiring an anatomical image volume with an anatomical image modality of higher spatial resolution than the physiological image modality;
co-registering the anatomical image volume and the physiological image volume such that both image volumes have corresponding voxels;
segmenting the anatomical image volume into a number of non-overlapping anatomical regions;
combining each of the segmented anatomical regions with a function representative of the limited spatial resolution of the physiological image modality to generate a blurred anatomical region volume for each of the segmented regions;
assuming the physiological image in each voxel to be a linear sum of the image intensities of the corresponding voxels in the blurred region volumes in that voxel;
estimating, for each voxel, a value representative of the contribution to that voxel from each blurred region volume based on the uptake measured by the physiological image for that voxel and for nearby voxels; and
using the estimated values for the voxels to estimate a true uptake of the tracer in each voxel and to thereby establish a corrected physiological image volume.

2. The method of claim 1, wherein the function representative of the limited spatial resolution of the physiological image modality is the point spread function of the image modality.

3. The method of claim 1, wherein the values for each voxel are estimated using regularised regression analysis.

4. The method of claim 3, wherein the regularised regression analysis is Tikhonov regularisation.

5. The method of claim 1, the method comprising: sliding a fixed volume made up of a plurality of voxels across the entire coregistered volume wherein the voxel of interest is a central voxel in each position of the fixed volume, wherein the step of estimating the value for each region in the voxel of interest is achieved by regression analysis based on the uptake measured by the physiological image of all the voxels in the fixed volume in that position of the volume.

6. The method of claim 5, wherein the fixed volume is a cube or a sphere of voxels centred on the voxel of interest.

7. The method of claim 5, wherein the contribution to the image of each central voxel from each of the blurred region image volumes is determined by regression analysis.

8. The method of claim 7, wherein the contribution to the image volume of a voxel g(r) is represented by the following equation:
$$g ( r ) = ( {\sum }_{nreg} {h}_{i} ( r ) \cdot {f}_{i} ( r ) ) + η ( r )$$
wherein hᵢ(r) is the factor representative of the limited spatial resolution, fᵢ(r) is the coefficient representative of uptake for each region and η(r) is the contribution of additive noise.

9. The method of claim 8, wherein the coefficient for each region is determined using the following regression analysis:
$$\tilde{f} ( r ) = {min}_{f ( r )} \{ {‖ h ( r ) f ( r ) - g ( r ) ‖}^{2} \} .$$

10. The method of any one of claim 5, wherein the fixed volume is a cube of 5×5×5 voxels.

11. The method of claim 1, wherein the step of estimating the true uptake of the tracer in each voxel based on the estimated values comprises selecting one of the estimated values to use as the basis for the correction to the measured uptake, the selected estimated value being that associated with the anatomical region identified with the voxel concerned.

12. The method of claim 11, wherein the anatomical region identified with the voxel concerned is determined by reference to the original anatomical image.

13. The method of claim 1, wherein the physiological and anatomical image volumes are acquired using a simultaneous physiological/anatomical imaging machine.

14. The method of claim 1, where the anatomical image volume is segmented based on class of tissue.

15. An image processing system configured to perform a method of estimating the true uptake of a tracer in a physiological image acquired with a physiological image modality that has limited spatial resolution, wherein the system is arranged to:
acquire a physiological image volume;
acquire an anatomical image volume with an anatomical image modality of higher spatial resolution than the physiological image modality;
co-register the anatomical image volume and the physiological image volume such that both image volumes have corresponding voxels;
segment the anatomical image volume into a number of non-overlapping anatomical regions;
combine each of the segmented anatomical regions with a function representative of the limited spatial resolution of the physiological image modality to generate a blurred anatomical region volume for each of the segmented regions;
assume the physiological image in each voxel to be a linear sum of the image intensities of the corresponding voxels in the blurred region volumes;
estimate for each voxel a value representative of the contribution to that voxel from each blurred region volume based on the uptake measured by the physiological image for that voxel and for nearby voxels; and
use the estimated values for the voxels to estimate a true uptake of the tracer in each voxel and to thereby establish a corrected physiological image volume.

16. The system of claim 15, wherein the system comprises an anatomical image scanner to take the anatomical image volume and a physiological image scanner to take the physiological image volume.

17. The system of claim 16, wherein the system comprises a simultaneous anatomical/physiological imaging machine so that anatomical and physiological images may be obtained simultaneously.

18. The system of claim 16, wherein the anatomical image scanner is a magnetic resonance imaging scanner.

19. The system of claim 16, wherein the physiological image scanner is a positron emission tomography scanner.

20. A computer program product comprising instructions that when executed on a data processing apparatus will configure the data processing apparatus to perform a method of estimating the true uptake of a tracer in a physiological image acquired with a physiological image modality that has limited spatial resolution, the method comprising:
acquiring a physiological image volume;
acquiring an anatomical image volume with an anatomical image modality of higher spatial resolution than the physiological image modality;
co-registering the anatomical image volume and the physiological image volume such that both image volumes have corresponding voxels;
segmenting the anatomical image volume into a number of non-overlapping anatomical regions;
combining each of the segmented anatomical regions with a function representative of the limited spatial resolution of the physiological image modality to generate a blurred anatomical region volume for each of the segmented regions;
assuming the physiological image in each voxel to be a linear sum of the image intensities of the corresponding voxels in the blurred region volumes in that voxel;
estimating, for each voxel, a value representative of the contribution to that voxel from each blurred region volume based on the uptake measured by the physiological image for that voxel and for nearby voxels; and
using the estimated values for the voxels to estimate a true uptake of the tracer in each voxel and to thereby establish a corrected physiological image volume.
